(19) United States
(12) Patent Application Publication
(10) Pub. No.: US 2011/0248665 A1
(43) Pub. Date: Oct. 13, 2011

(54) Mobile docking station

(76) Inventors: Frank R. Smith, Huntington Beach, CA (US); David L. Lark, Corcoran, CA (US)

(21) Appl. No.: 12/662,316

(22) Filed: Apr. 9, 2010

(51) Int. Cl. H01M 10/46; H02J 17/00; G03B 21/00

(52) U.S. Cl. 320/101; 353/122; 353/10; 307/104

(57) ABSTRACT

The mobile docking station is compact, making it easily handheld, and attaches to a variety of small mobile devices, such as smart phones, media players, and the like. The mobile docking station provides a platform for delivery and display of short-range multi-gigabit data, video, and audio to a receptive object within range either indoors or outdoors. A Matrix Chip contains an energy-informed film that acts as a filter between the human body and sources of electronic radiation (EMR) to shield the user from harmful effects of electromagnetic energy generated by the attached electronic mobile device. A solar panel chip stores, recharges, and harvests wireless light energy to power the unit and attached mobile devices. The wireless mobile docking station electronically connects to the docked equipment to provide 60 GHz communication at very high data rates.

### BACKGROUND OF THE INVENTION

1. Field of the Invention

The present invention relates to a mobile docking station having a charging mechanism and a high-speed data transceiver for an attached mobile electronic device.

2. Description of the Related Art

Mobile electronic devices, such as cellular phones, smart phones, media players and personal digital assistants (PDA's), are popular devices that are widely used. Advances in such mobile devices have included the addition of games, music, movies, and high-powered business applications for example. These advanced applications have placed a power burden and data throughput burden on the existing mobile devices. For example, the display screens of the mobile devices are small enough to possibly cause eyestrain when viewed for long periods of time. Moreover, the advanced applications, coupled with the user's tendency to have these mobile devices powered up for long periods of time, have resulted in frustration among the users, in that they must schedule time-out periods in which their devices are tethered for recharging and, thus, not mobile during the time-out period. Another source of frustration among users is the ever-increasing demand upon their devices for high-speed file transfer and high speed streaming of critical real-time data. There is a need for a solution to the power-charging problem and a concurrent solution to the data throughput problem.

Thus, a mobile docking station solving the aforementioned problems is desired.

### SUMMARY OF THE INVENTION

The mobile docking station has a compact form, which makes it easily handheld, and is attachable to a variety of small mobile devices, such as smart phones, media players, and the like. The mobile docking station provides a platform for delivery and display of short range, multi-gigabit data, video, and audio to a receptive object within range, either indoors or outdoors. A Matrix Chip contains an energy-informed film that acts as a filter between the human body and sources of electronic radiation (EMR) to shield the user from harmful effects of electromagnetic energy generated by the attached electronic mobile device. A solar panel chip stores, recharges, and harvests wireless light energy to power the unit and attached mobile devices. The wireless mobile docking station electronically connects to the docked equipment to provide 60 GHz communication at very high data rates.

These and other features of the present invention will become readily apparent upon further review of the following specification and drawings.

### BRIEF DESCRIPTION OF THE DRAWINGS

FIG. 1 is a perspective view of the mobile docking station according to the present invention.

FIG. 2 is a front perspective view of the mobile docking station according to the present invention.

FIG. 3 is a diagrammatic view of electronic systems of the mobile docking station according to the present invention.

FIG. 4 is a diagram depicting a mobile docking station according to the present invention providing communication over a WAN.

FIG. 5 is a diagrammatic view of a mobile docking station according to the present invention, shown in use as a holographic projector.

FIG. 6 is a perspective view of a platform of a mobile docking station according to the present invention.

FIG. 7 is a diagram of a mobile docking station according to the present invention, depicting the process of screen projection.

FIG. 8 is a diagram of a mobile docking station according to the present invention, depicting the process of wall projection.

FIG. 9 is a diagram schematically depicting a mobile docking station according to the present invention communicating to wireless devices.

FIG. 10 is another diagram schematically depicting a mobile docking station according to the present invention communicating to wireless devices.

FIG. 11 is a perspective view of a mobile docking station according to the present invention.

FIG. 12 is a perspective view of the mobile docking station according to the present invention, shown connected to a laptop computer via a universal cable.

Similar reference characters denote corresponding features consistently throughout the attached drawings.

### DETAILED DESCRIPTION OF THE PREFERRED EMBODIMENTS

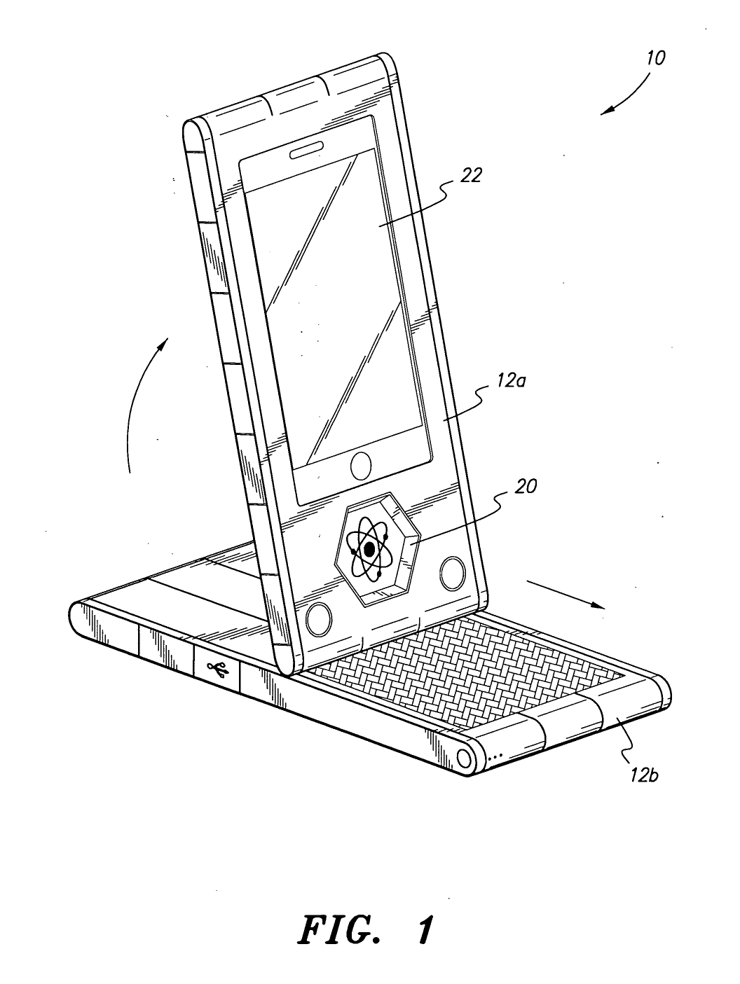

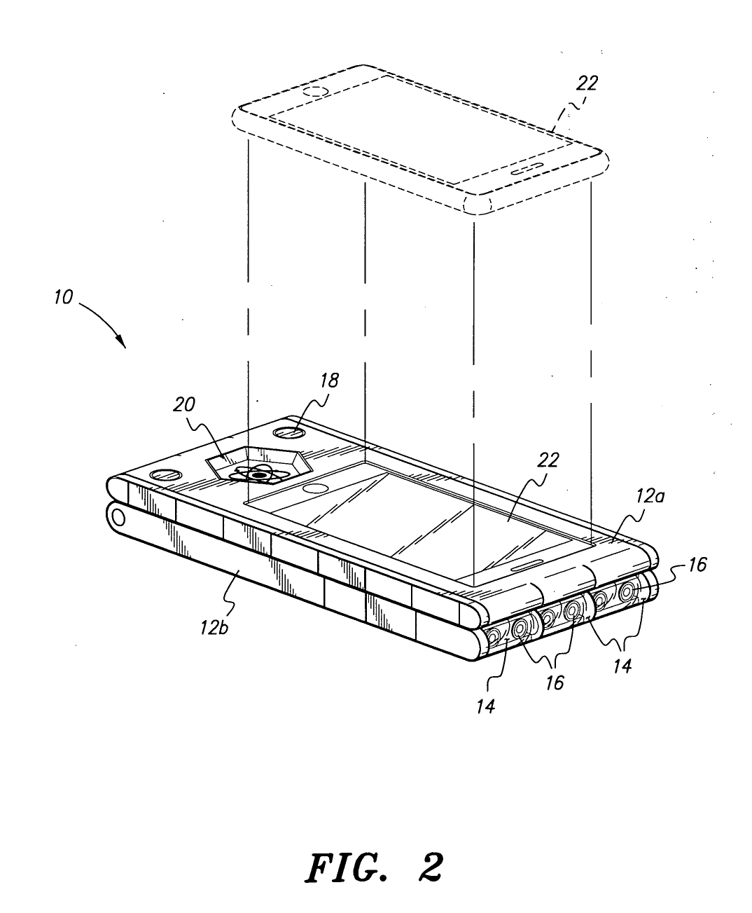

As shown in FIGS. 1 and 2, the mobile docking station 10 has a compact form, which makes it easily handheld, and attaches to a variety of small mobile devices, such as smart phones, media players, and the like. The mobile docking station 10 provides a platform for delivery and display of short range, multi-gigabit data, video, and audio to a receptive object within range, either indoors or outdoors. The docking station 10 comprises an upper mobile device docking housing 12a and a lower base housing 12b. Preferably the housings 12a and 12b are made of a titanium-based bulk metallic glass material. The upper docking housing 12a is adapted to receive, hold, and release smart phones, such as Apple IPhone, Google-Nexus One, Microsoft HD ZUNE Media Player, Nokia, and RIM (Blackberry). Image projectors 16, preferably using an RGB laser, are disposed in the front portion of the base housing 12b and are covered by clear projector covers 14. Dual circular members 18 are disposed on top of opposing lateral sides of the upper docking housing 12a. A hexagonal recess 20 is disposed in the upper docking housing 12a between the dual circular members 18. The user's mobile device 22 fits in a docking space defined by peripheral edges of the upper docking housing 12a.

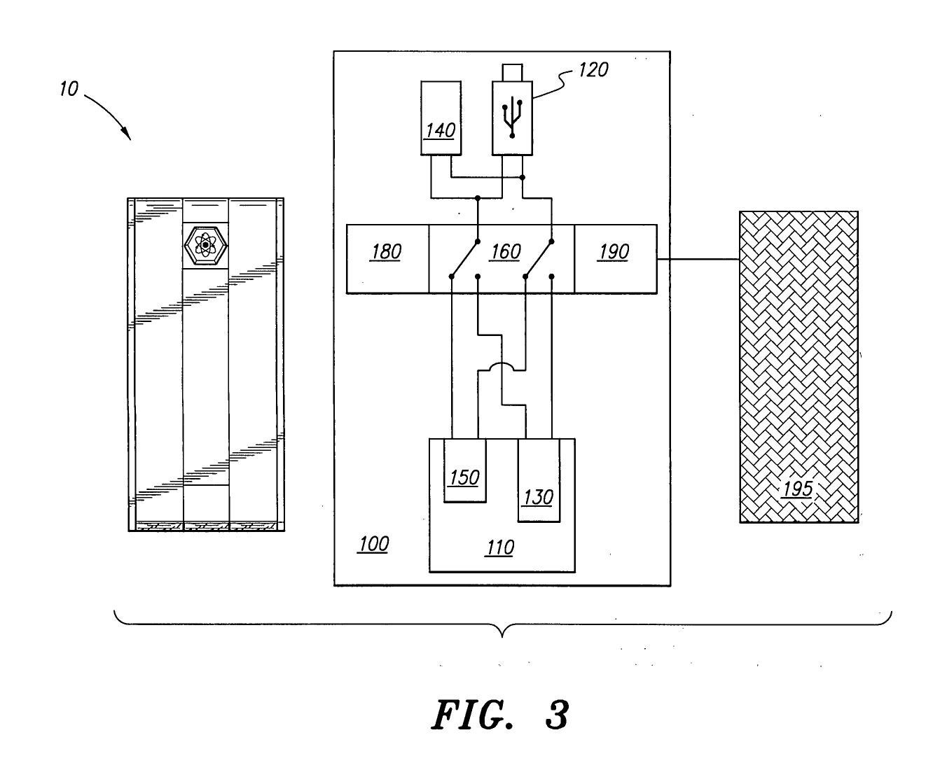

As shown in FIG. 3, a Matrix Chip 180, available from www.matrixeurope.com/newsite/, contains an energy-informed film that acts as a filter between the human body and sources of electronic radiation (EMR) to shield the user from harmful effects of electromagnetic energy generated by the attached electronic mobile device. The chip 180 is in operable communication with the transceiver 100. It is theorized that the matrix chip 180 works by interfering with and neutralizing negative health effects of electromagnetic energy generated by cell phones and other electronic devices. The function of human cells is not only influenced by nutrients, medicines and hormones, but also by energy information.

Cell phones produce electromagnetic radiation, and the resulting energy penetrates the body and disturbs the natural energy state of cells. This disruption may alter cell signaling pathways, permeability of ion-exchange channels, membrane electric potential, etc., of human cells, and may lead to damaging health consequences. Just like music information stored on a CD, energy information can be stored on a carrier material like the Matrix chip in the form of a binary code through a pulse generator. As this very low frequency energy is released in pulses, like medicine from a time-release capsule, it creates a noise field that has a neutralizing effect on the energy produced by cell phones.

Man-made electronic devices usually produce energy that has a uniform and regular wave pattern in terms of frequency and amplitude. On the other hand, natural sources of energy generally produce mixed wave patterns with irregular profiles. Studies show that it is these non-random, repetitive energy waves that produce harmful biological effects. Moreover, it is further conjectured that superimposing a “noise-field” through pulses of energy produced by the matrix chip 180 converts these repetitive, regular, man-made energy waves into more random, natural electromagnetic fields, and mitigates their hazardous potential to biological systems.

A power chip 190 is a micro energy cell, such as an MEC10175ES, available from www.infinitepowersolutions.com. The micro energy cell 190 stores, recharges, and harvests wireless light energy to power the unit 10 and attached mobile devices. Additionally, the micro energy cell 190 may include a passive power management circuit, which is also available from InfinitePower Solutions (IPS). The micro energy cell 190 is connected to a Solar Panel Chip 195, which trickles in the electrical energy required for charging, storing, and delivering electrical power to the mobile docking station 10 and attached mobile electronic device 22.

Multiple solar cells 195 are arranged on the surface of the mobile docking station 10 so that a number of solar cells 195 may always be functional and produce a desired voltage, even if the remainder is obstructed. Power management status information is displayed either on a main display of the docking station 10, or directly above the solar cells 195. The solar cells 195 are typically stacked and laminated with layers made of transparent or semi-transparent materials. These layers are glued with shock absorbent materials. Some of these layers may be used for display or input purposes, and some layers may be coated with various materials, or they may be etched with product logos or other patterns. This stack of layers may be attached to the device's frame through a shock-absorbing device or material.

The power circuitry 190 contains a boost converter to change the voltage coming from the solar cells 195 to a value suitable for batteries, or for the docking unit 10. The electric power generated from the solar cells 195 can be used either to charge rechargeable batteries, or to directly power the channel switch 160 and associated docking station components, or both. The channel switch 160 and associated docking station components can also be powered directly by batteries. Rechargeable batteries can be charged by the solar cells 195, as well as external power sources.

A solar cell panel 195 is embedded inside the front side of the device, where no other functional units are found. The solar cell layer is coupled mechanically and electronically to a flexible printed circuit board (PCB). The power produced from the solar cell is transferred to the layer. The solar cell layer may be stacked with various layers made of transparent or semi-transparent materials, which serve, among other things, as protective layers. These layers are glued with shock absorbent materials. Some of these layers may be used for display or input purposes, and some layers may be coated with various materials, or they may be etched for design purposes.

The wireless mobile docking station 10 electronically connects to the docked equipment 22 to provide high GHz, e.g., 60 GHz communication at very high data rates.

A “Universal 7G wireless connector” comprises a 7G wireless transceiver 100, which includes a 7G wireless emitter 110, a connector 120, a digital signal processor 130, an audio signal connector 140, an analog signal processor 150, a transceiver channel switch 160, a matrix chip 180, and a power solar chip 190. All of the aforementioned electronic circuitry is in operable communication to provide the required functionality of the mobile docking station 10.

The wireless transceiver 100 can be electronically connected to a mobile electronic device, e.g., an iPhone 22, and exchanges data between device 22 and the docking station 10 via very high speed wireless signals. The connector 120 electronically connects the docking station 10 to the electronic device 22. It should be understood that while an iPhone is shown as the mobile device 22, any mobile device, such as a cellular phone, a projection phone, a smart phone, a personal digital assistant (PDA) device, an electronic game system, a digital video disc (DVD) player, a media player, or the like, may be connected to and used with the mobile docking station 10. The digital signal processor 130 is electronically connected to the wireless emitter 110, and the digital signal processor 130 may be in operable communication with the universal connector 120. However, the wireless transceiver 100 is preferably modularized, embedded and disposed within the docking station 10, thus a separate transceiver housing is not necessary.

Digital signals are input for processing by digital signal processor 130, and are then transferred via the universal connector 120. The digital signal processed by DSP 130 is then transmitted to another display or electronic device, which may receive 7G signals wirelessly for transmission by the 7G wireless emitter 110. The channel switch 160 is electronically connected to the 7G wireless emitter 110. The channel switch 160 may also be connected to an audio signal connector 140.

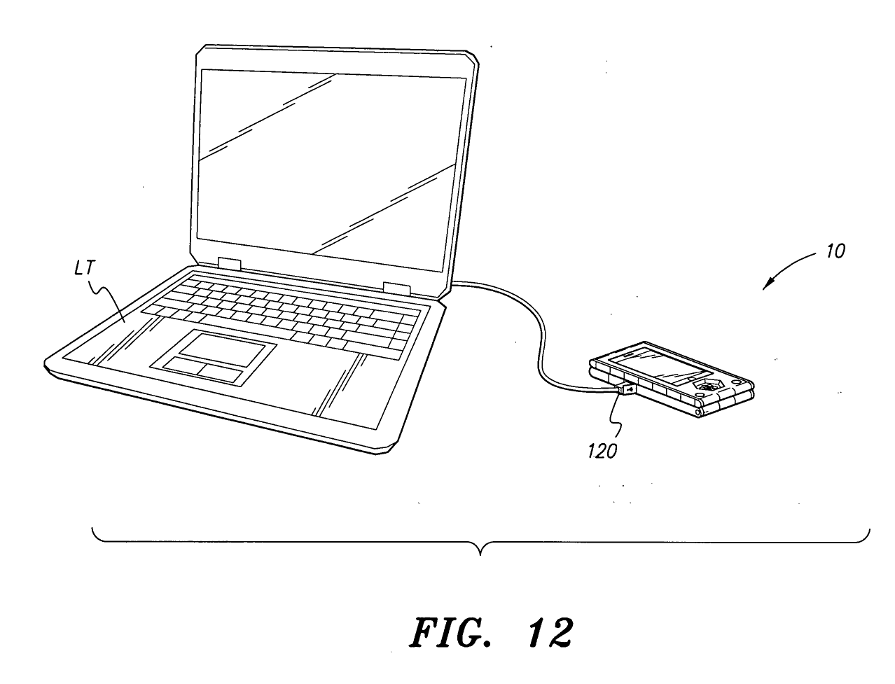

As shown in FIG. 12, the mobile docking station 10 may be connected to a laptop computer LT for data transfers via the universal connector 120.

Thus, the transceiver 100 can have connectivity to an external display or electronic device. Moreover, the user also may connect an electronic device having an audio signal output port to the wireless transceiver 100 via universal connector 120, and the signals may be transmitted wirelessly between the docked electronic device and other electronic devices.

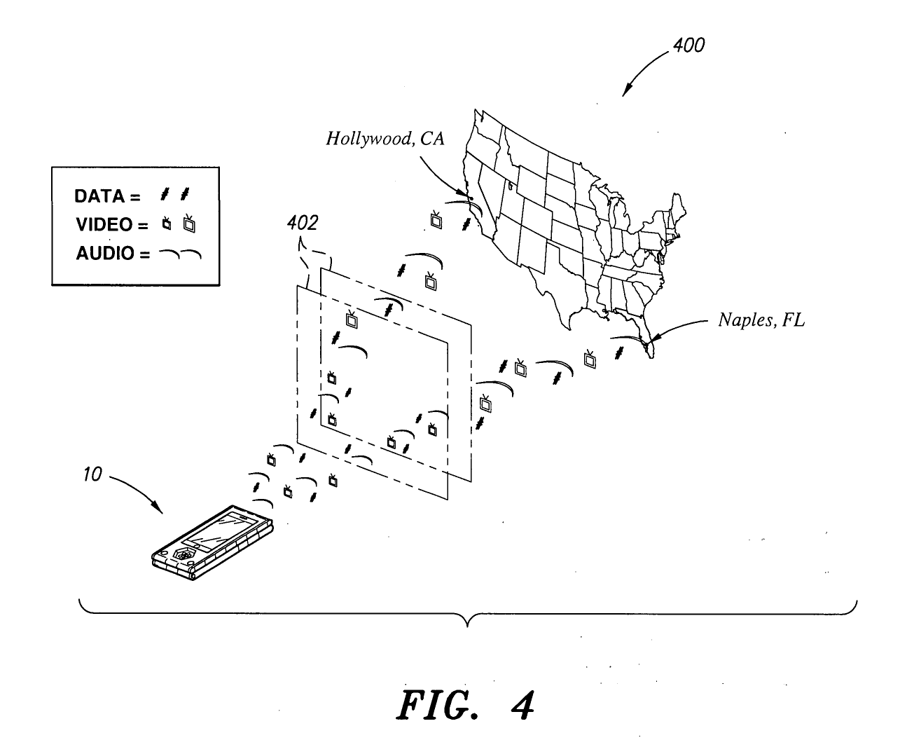

The mobile docking station 10 provides a single, multi-functional, mobile docking station, which delivers and displays short-range multi-gigabit data/video/audio to an object in an indoor/outdoor environment. As shown in FIGS. 3 and 4, the mobile docking station 10 provides a combination optical-interconnect/wireless mobile transceiver 100 that transmits data/video/audio. Channel switch 160 is an application specific integrated circuit (ASIC) having circuitry connected to digital signal processor 130 and analog signal processor 150 of the transmitter 110 to thereby form an integrated optical channel 402 capable of Wide Area Coverage 400, and theoretically provides around ten times the bandwidth of existing technologies.

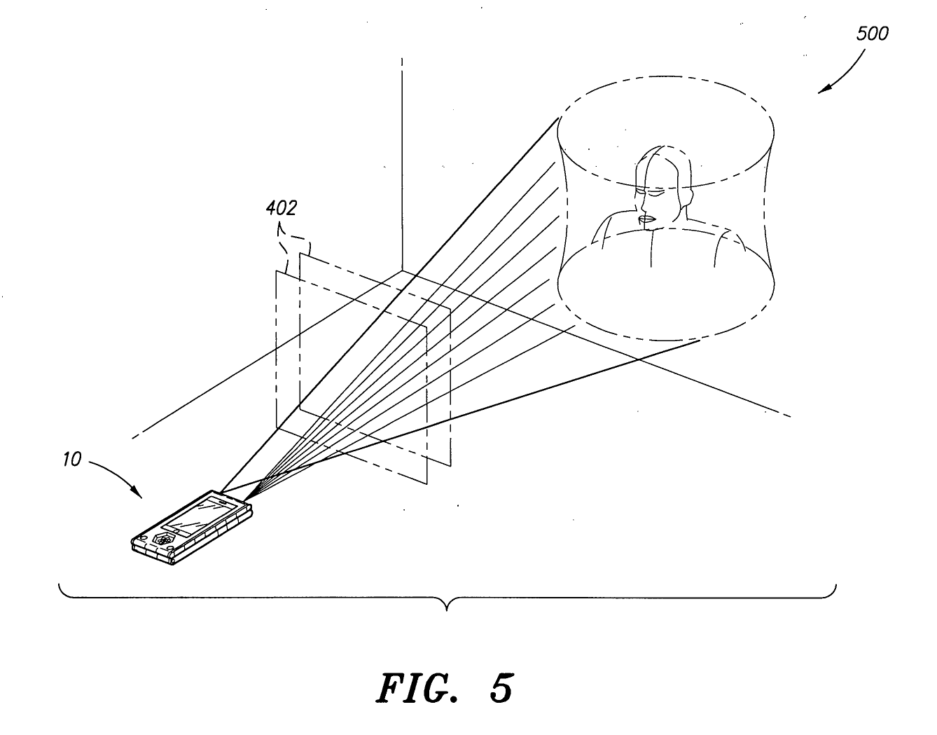

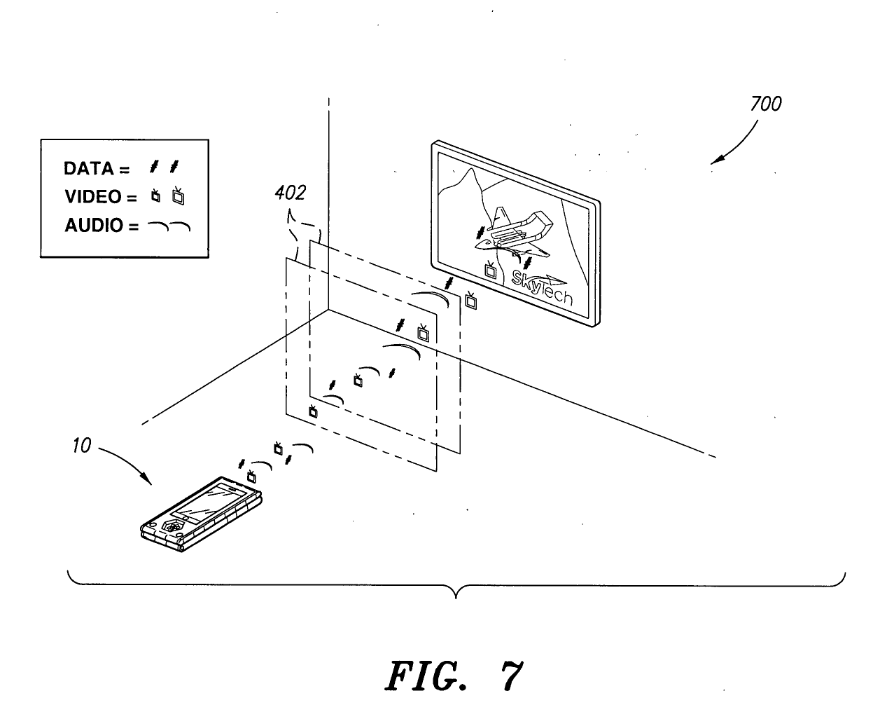

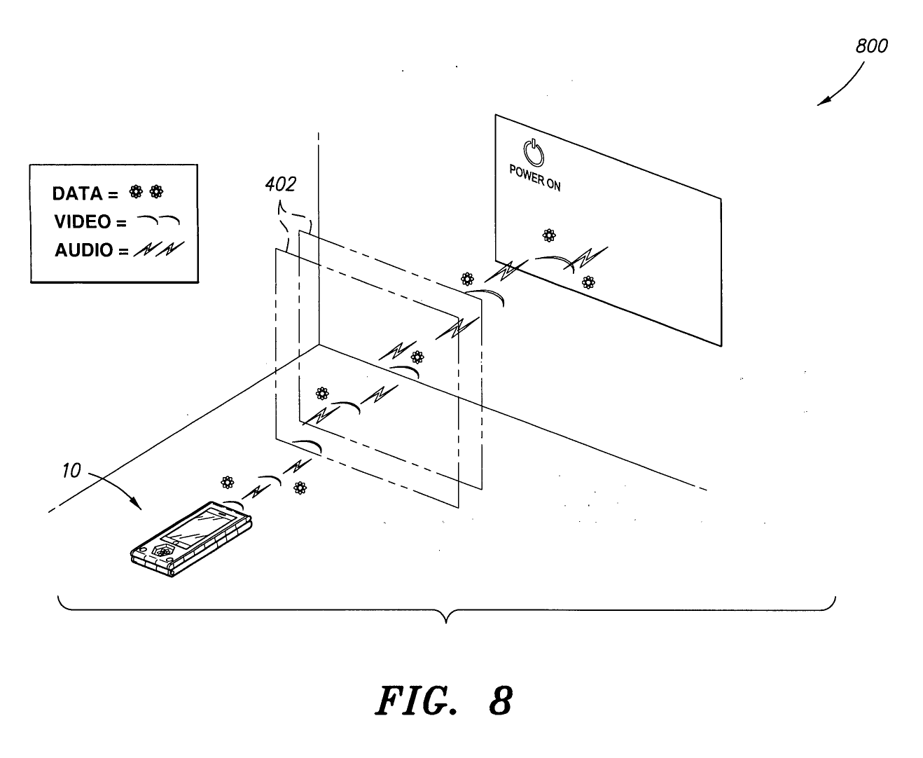

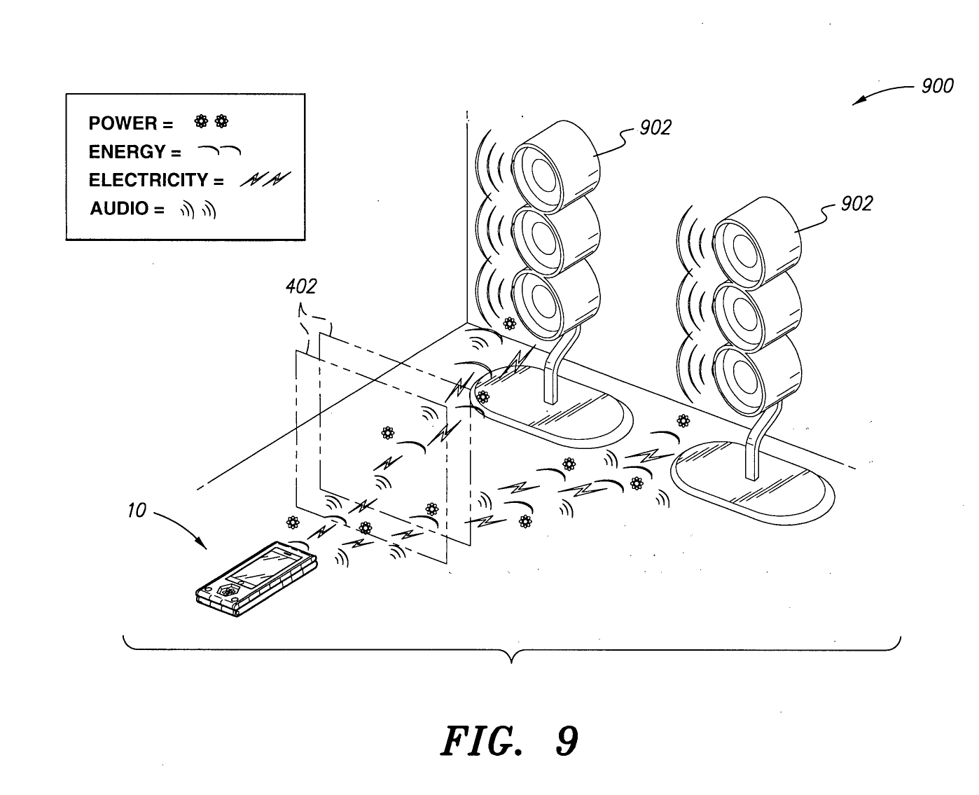

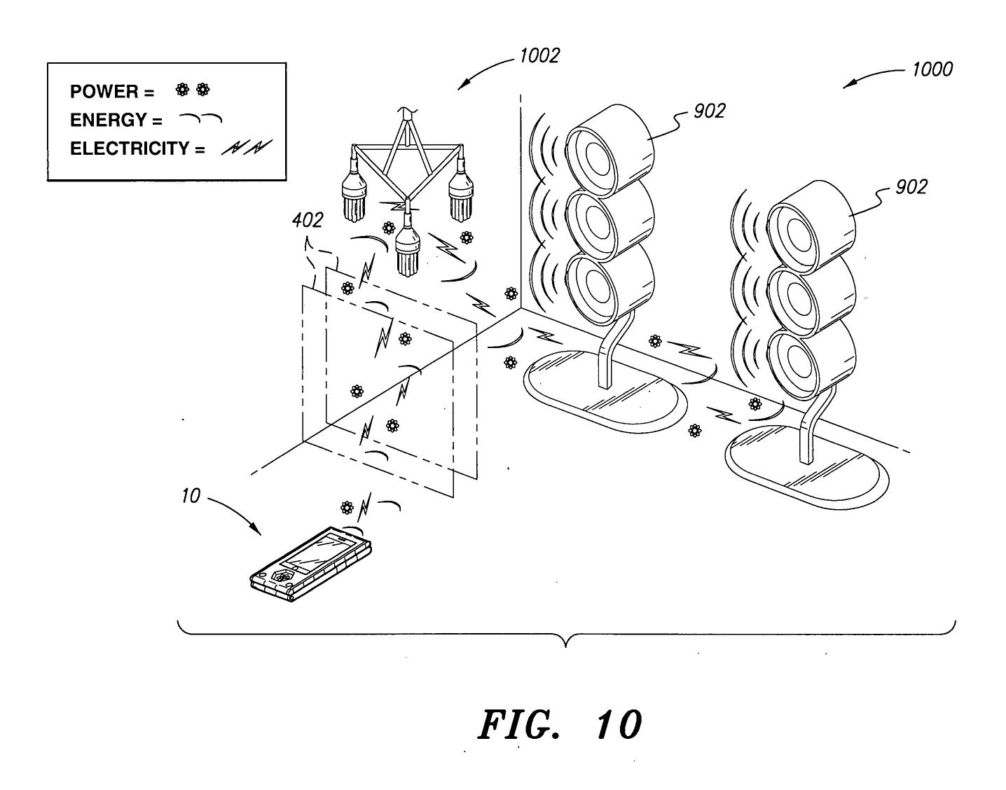

FIG. 5 shows the mobile docking station 10 forming the integrated optical channel 402 to project a holographic image into a 3D spatial volume 500. As shown in FIG. 7, the mobile docking station 10 can form an integrated optical channel 402 to display images on a wallpaper thin OLED surface 700. As shown in FIG. 8, in a space 800 defined by wall surface W, the mobile docking station 10 can form an integrated optical channel 402 to display images on the wall surface W. As shown in FIG. 9, the mobile docking station 10 can form an integrated optical channel 402 to power up and drive audio speakers 902 in room 900. Additionally, as shown in FIG. 10, the mobile docking station 10 can utilize the integrated optical channel 402 to actuate OLED lamps 1002 in a lamp-equipped room 1000.

The mobile docking station 10 can also project images on wall-sized multi-touch projection screens, plasma screens, LCD screens, Laser TV 3D Immersive technologies, OLED lighting, OLED surveillance cameras, satellite radio, and multi-touch tabletop screens. Moreover, every display type can be used simultaneously as the docking station 10 routes data selectively to the aforementioned displays.

The integrated optical channel 402 has the capability of delivering a new wave of Holographic Video content, Laser-Interactive-Immersive-Gaming-Holographic-Technology, to a mobile device via a Data Center/Virtualization Cloud Service. The integrated optical channel 402 is a virtualized, preferably quantum, communication channel, which is co-spatial in nature, where both real world objects coexist in three-dimensional space, with digital information transmitted by the mobile docking station 10.

The integrated optical channel 402 provides a means for generating true high fidelity, full color, high-resolution freespace video or still images with interactive capabilities. The composed video or still images are clear, have a wide viewing angle, possess additional user input interactive capabilities, and can render discrete images, each viewed from separate locations surrounding the device. All of these attributes are not possible with present augmented reality devices using existing fog screen projections and current displays. The integrated optical channel 402 programs execute in real space. Direct interaction is with the room's wall surfaces, OLED screens, and computers. The mobile docking station 10 redefines the architectural layout of our living space by supporting collaborative decision and creative making environments, limited in the past to unidirectional physical display surfaces.

It is conjectured that the integrated optical channel 402 also transports wirelessly data/audio and immersive holographic video data at up to 5-10 gigabits per second, ten times the current maximum wireless transfer rate. For example, consumers will be able to transport a high definition DVD from the mobile docking station 10 to an OLED screen or paper-thin wallpaper substrate-walled surface in two seconds. The mobile docking station 10 can then autosync content from one computer, or stream content from up to five additional computers, or write to any object.

Preferably, a core of integrated optical channel 402 originates in a Data Center/Virtualized Cloud Service. The capacity requirements, including growth of mobile and video applications, are creating new multidirectional traffic patterns with the increasing emergence of the virtualized data center cloud. The integrated optical channel 402 incorporates a novel spectrum assignment algorithm (whitespace discovery and utilization) that is able to handle spatial variation of the spectrum, as well as spectrum fragmentation, and communicates with the mobile docking station 10, which is the world's first white space fabricated quantum UHF translator device that is integrated on a single silicon Integrated circuit chip and operates at 60 GHz on the CMOS process side-by-side with laser projector regular circuits and switches.

The integrated optical channel 402 formed by ASIC channel switch 160 uses an efficient, time domain signal analysis technique, known by persons having ordinary skill in the art, as SIFT (Signal Interpretation before Fourier Transform), that allows clients to rapidly discover access points (AP's) transmitting on the assigned integrated optical channel 402. The mathematical model of an integrated optical channel 402 is a channel in the Heisenberg picture (quantum channel) and is well known to those of ordinary skill in the art. However, it is believed that the Heisenberg channel formation has heretofore never been implemented in a mobile docking station. Thus, the mobile docking station 10 can transceive information using classic binary digits (bits) and/or quantum binary digits (qubits).

The integrated optical channel 402 is a private white space channel, which can access a virtualized cloud computing distributed hosting framework service via forming a single link over extremely high frequencies, e.g. 60 GHz white spaces. The integrated optical channel 402 may be assigned a set of frequencies, which overlays UHF (or other predetermined range of spectrum) white space. The transceiver 100 detects the presence of existing signals, such as HD TV stations and other wireless users, and avoids the use of these channels.

The integrated optical channel 402 provides a method for deploying, via a cloud computing service application, 3D Holographic (Free Space) object imaging that emancipates digital information into the real world, thereby allowing a closer and more intuitive interface between virtual information and its user.

The co-spatial nature of the input/output field compresses information-space where both real world objects coexist in three-dimensional space with digital information. This mobile docking station platform 10 redefines the architectural layout of our living space by supporting collaborative decision and creative making environments, limited in the past to unidirectional physical display surfaces.

WAN services are an important extension of the integrated optical channel 402 architectural approach to a virtualized holographic systems deployment. A converged WAN edge solution is preferably deployed to address evolving business objectives while integrating with the capabilities of the integrated optical channel 402. Preferably, next generation router technologies are used in conjunction with the mobile docking station

The integrated optical channel 402 takes advantage of advanced network-processor technology foreseen to replace existing infrastructure.

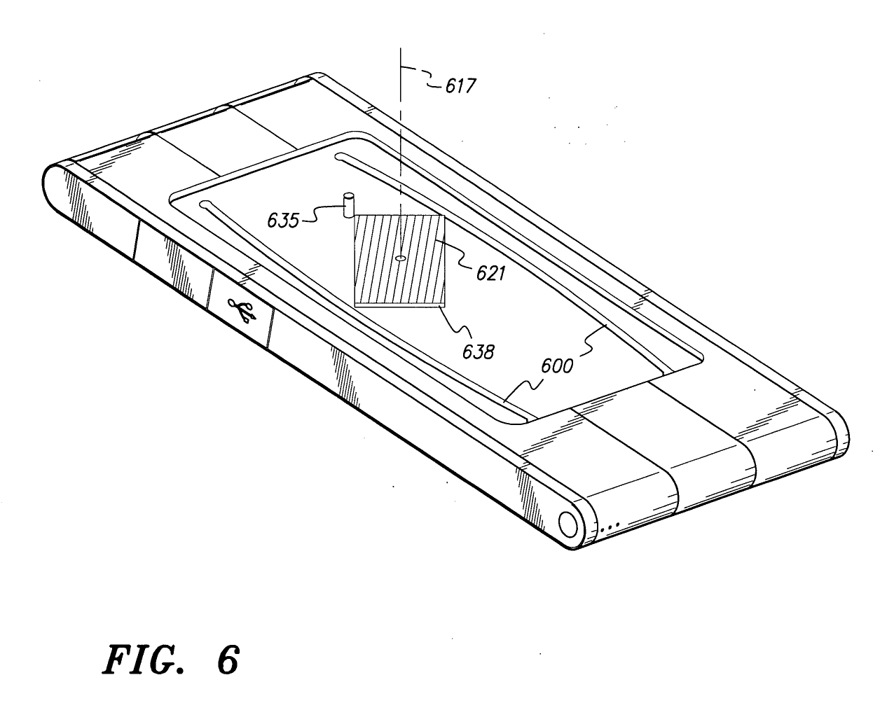

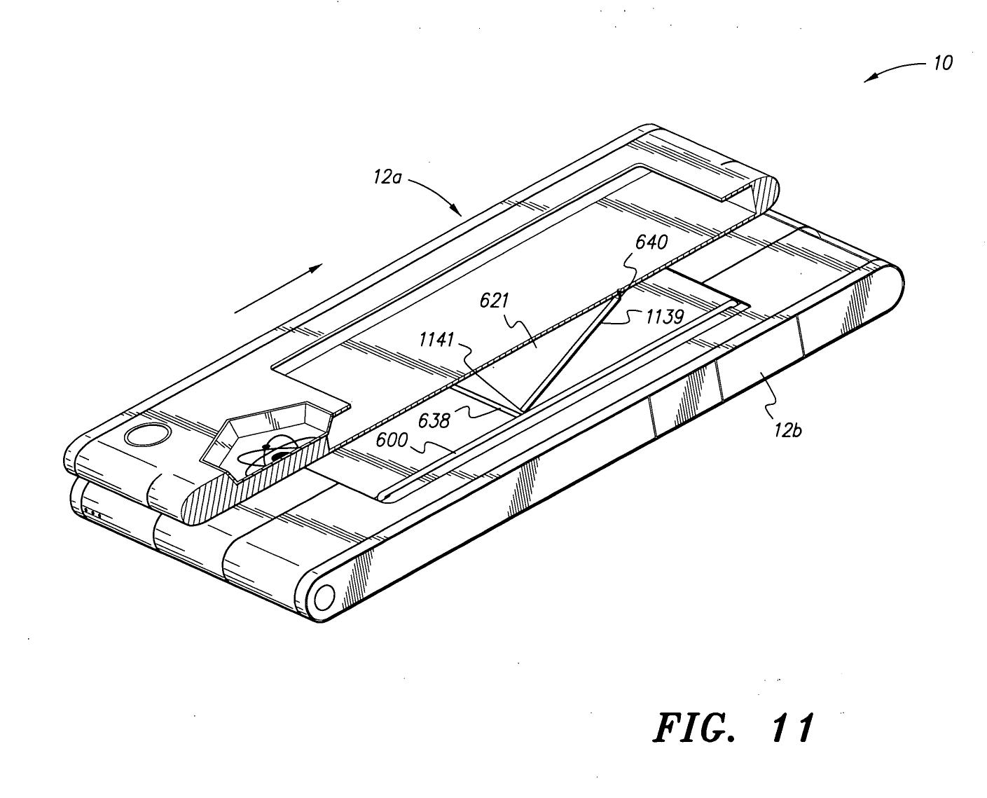

As shown in FIGS. 6 and 11, an electromagnetic universal pivot mechanism having a sliding cam 621 is provided to allow custom positioning of the upper docking portion 12a with respect to the base portion 12b. The cam 621 of the electromagnetic universal pivot/slide mechanism is disposed in a recess of base housing 12b and connected to mobile device attachment housing 12a. The base housing 12b and device attachment housing 12a are slidably hinged together.

The device attachment housing 12a can slide longitudinally along the base housing 12b. Moreover, the device attachment housing 12a can pivot with respect to the base housing 12b, as shown in FIG. 1.

This structure is extremely simple and very compact. It easily fits in the very shallow space between the two enclosures, making a single multi-functional mobile docking station 10. Two identical elongate spring steel members 600 symmetrically flank the electromagnetic cam 621 and contact the pivoting cam 621 on its opposing corners 638 or edges, thereby eliminating any significant radial stress at pivot axis 617. This configuration of the cam 621 allows positioning of the device attachment housing 12a end-to-end along the base housing 12b. The polygonal shape of electromagnetic cam 621 allows for custom design of cam stopping positions. In the embodiment shown, the cam 621 has two pairs of parallel flat sides, each engaging the spring members 600 in a respective one of the open and closed positions. The parts are generally congruent, and the upper and lower housing components 12a and 12b substantially cover the pivot mechanism recess in the closed position.

The spring members 600 are preferably rod-shaped steel. The remaining pivot/slide mechanism components can be made of a durable plastic. Ends of the spring members 600 are securely seated in opposing longitudinal end portions of the base housing 12b. It is conjectured that by virtue of the cam 621 being electromagnetic, it may also be used as a means for guiding electromagnetic energy emanating from an attached mobile device 22. A pin 635 extends vertically from the cam 621. The corners 638 of the cam 621 spread the spring elements 600 in a metastable center position. In a simple system, the cam 621, being substantially square, moves through 90° between its end positions.

A link bar 1139 has a bent-up end 640, which is pivotally attached to a central portion of the upper docking portion 12a. The opposite end 1141 of the link bar 1139 is bent down and pivotally attached to the cam 621 adjacent one of the corners 638, offset outward from the axis 617. With this system, therefore, as the upper docking portion 12a slides longitudinally along the lower portion 12b, the electromagnetic cam 621 pivots.

It is to be understood that the present invention is not limited to the embodiment described above, but encompasses any and all embodiments within the scope of the following claims.

I claim:

1. A mobile docking station, comprising:
a compact, portable housing adapted for receiving, holding, and releasing a mobile electronic device;
a renewable energy charging source disposed in the housing;
a mobile electronic device charging port disposed in the housing, the port having an input and an output, the renewable energy charging source being connected to the input of the port; and
a charging circuit connected to the port input for charging the mobile electronic device when the mobile electronic device is connected to the output of the port.

2. The mobile docking station according to claim 1, wherein said renewable energy charging source comprises a micro energy cell.

3. The mobile docking station according to claim 2, wherein said renewable energy charging source further comprises a solar cell in operable communication with said micro energy cell.

4. The mobile docking station according to claim 1, further comprising a projection system disposed in said housing, the projection system being adapted for operable connection to the mobile electronic device, the projection system having means for projecting an image transferred from the mobile electronic device for viewing of the image.

5. The mobile docking station according to claim 4, wherein said projection system has means for projecting the image from the mobile electronic device onto a planar surface.

6. The mobile docking station according to claim 5, wherein said projection system has means for projecting the image onto an OLED projection screen.

7. The mobile docking station according to claim 4, wherein said projection system has means for projecting and focusing the image into a 3-dimensional volume, thereby forming a holographic image.

8. The mobile docking station according to claim 1, wherein said housing has an upper portion and a lower portion, the upper portion being slidably pivotal 180° over the lower portion.

9. The mobile docking station according to claim 8, further comprising a cam member configured for locking the upper portion at a user selected angle relative to the lower portion.

10. The mobile docking station according to claim 1, further comprising:
a transceiver disposed in said housing, the transceiver being adapted for operable connection to the mobile electronic device;
a processor disposed in said housing, the processor being connected to the transceiver, the processor being configured for controlling the transceiver by executing a spectrum whitespace discovery and utilization algorithm, thereby enabling a transceive channel defined over a predetermined range of the electromagnetic spectrum.

11. The mobile docking station according to claim 10, wherein the range of electromagnetic spectrum is in an optical portion of the electromagnetic spectrum.

12. The mobile docking station according to claim 10, further comprising an electronic radiation barrier disposed inside of said housing, the electronic radiation barrier shielding a user from harmful effects of electromagnetic energy generated by the attached mobile electronic device.

13. The mobile docking station according to claim 10, wherein said transceiver has means for transmitting and receiving classical binary digit information.

14. The mobile docking station according to claim 10, wherein said transceiver has means for transmitting and receiving quantum binary digit information.

15. The mobile docking station according to claim 10, wherein said transceiver has a transmitter circuit configured for transmitting power to energize a nearby device.

16. A mobile docking station, comprising:
a compact, portable housing adapted for receiving, holding, and releasing a mobile electronic device;
a renewable energy charging source disposed in the housing;
a mobile electronic device charging port having an input and an output, the renewable energy charging source being connected to the input of the port a charging circuit disposed in the housing for charging the mobile electronic device when the mobile electronic device is connected to the output of the port;
a transceiver disposed in the housing, the transceiver being adapted for operable connection to the mobile electronic device; and
a processor disposed in the housing, the processor being connected to the transceiver, the processor being configured for controlling the transceiver by executing a spectrum whitespace discovery and utilization algorithm, thereby enabling a transceive channel defined over a predetermined range of the electromagnetic spectrum.

17. A mobile docking station, comprising:
a compact, portable housing adapted for receiving, holding, and releasing a mobile electronic device;
a transceiver disposed in the housing, the transceiver being adapted for operable connection to the mobile electronic device, the transceiver having means for transmitting and receiving encoded digital data, the encoded digital data being selected from the group consisting of classical binary digit information and quantum binary digit information; and
a processor disposed in the housing, the processor being connected to the transceiver, the processor being configured for controlling the transceiver by executing a spectrum whitespace discovery and utilization algorithm, thereby enabling a transceive channel defined over a predetermined range of the electromagnetic spectrum.

18. The mobile docking station according to claim 17, wherein the range of the electromagnetic spectrum is in an optical portion of the electromagnetic spectrum.
